(19) United States
(12) Patent Application Publication
(10) Pub. No.: US 2023/0161486 A1
(43) Pub. Date: May 25, 2023

(54) METHOD FOR MANAGING A MEMORY IN A SYSTEM-ON-A-CHIP

(71) Applicant: STMicroelectronics (Grand Ouest)SAS, Le Mans (FR)

(72) Inventors: Loic Pallardy, Rouillon (FR); Michel Jaouen, Yvre I'eveque (FR)

(21) Appl. No.: 18/058,613

(22) Filed: Nov. 23, 2022

(30) Foreign Application Priority Data
Nov. 25, 2021 (FR) 2112499

(51) Int. Cl. G06F 3/06

(52) U.S. Cl. CPC G06F 3/0622; G06F 3/0637; G06F 3/0673

(57) ABSTRACT

In accordance with an embodiment, a method for managing a memory within a system-on-a-chip including a processor, a memory and a firewall device, includes: generating, by the processor, a request to access the memory, where the request has a access permission level; controlling, by the firewall device, access to the at least one memory region of the memory as a function of the access permission level of the request and a respective access permission level associated with at least one memory region; and erasing, by the firewall device, the at least one memory regions when its respective access permission level is modified, where erasing comprises performing a hardware-implemented erasure.

### CROSS-REFERENCE TO RELATED APPLICATIONS

This application claims the benefit of French Patent Application No. 2112499, filed on Nov. 25, 2021, which application is hereby incorporated herein by reference.

### TECHNICAL FIELD

Embodiments and implementations relate to systems and methods for managing a memory in a system-on-a-chip.

### BACKGROUND

Firewalls are typically provided for security reasons when one or more applications from different software execution contexts, and potentially from different processors, need to access the same memory of the system-on-a-chip, for example the memory in which a software system is stored.

In this respect, each application has an access permission level, allowing the firewall to define whether or not it is authorized to access a memory region of the memory. The access permission level of an application typically comes from the execution context from which it originates. For example, a software system can provide an execution context with “secure” access permissions (typically referred to as a “Secure OS”) and an application execution context with “non-secure” access permissions (typically referred to as a “Rich OS”).

The firewall is conventionally intended to allocate, upon a command from the software execution context with “secure” access permissions, the different memory regions to respective execution contexts (each corresponding to an access permission level); and, on the other hand, to filter, i.e. to grant or deny, the requests to access the different memory regions as a function of the access permission level of said requests. The firewall is typically configured during the initialization of the system to define access to the memory regions for the different execution contexts of the system.

A memory region can be allocated exclusively to one execution context or shared between a plurality of execution contexts. Nonetheless, the number of applications for a software execution context can be high and the storage space of the memory can be insufficient to store all the application data. The memory thus becomes a critical resource, in particular on an embedded system where the hardware of the memory cannot be changed during the life of the system.

For greater efficiency, a memory region can be associated with different execution contexts during operation of the system depending on the applications being executed. Thus, the firewall can be reprogrammed in order to reconfigure the access permissions to the memory regions, after the system has been initialized, during the execution of the software system and the applications.

For example, a secure display function with hardware image rotation consumes two buffered secure memory regions, one containing a frame of the secure image to be displayed on top of the non-secure image frame, the other containing a frame of the image resulting from the rotation which must also be secure. In the case of a high-resolution image, each buffered memory region can be large, for example 8 MB for a 1080p resolution.

When the secure display is not enabled, the memory regions are typically allocated to the execution context, of the software system, with non-secure access permissions (“Rich OS”), to be used as a cache or by another application. When the secure display is enabled, the memory regions are retrieved by the execution context, of the software system, with secure access permissions (“Secure OS”), and the firewall is reconfigured to modify the access permissions of said memory regions. Moreover, when the secure display is disabled, the reverse sequence must be carried out.

Furthermore, before returning the memory regions to the execution context, of the software system, with non-secure access permissions (“Rich OS”), the contents of the memory regions must be erased to prevent data leakage.

This operation is under the control of the execution context, of the software system, with secure access permissions (“Secure OS”), and if a hacker manages to bypass this operation or if a third-party programmer does not provide for the implementation thereof, the contents of the secure memory regions will become visible to the non-secure execution context. In other words, the secure erasure of the memory regions is the responsibility of a software feature, which should be implemented by the secure execution context of the software system, however, the software application is responsible for the use of this feature since it depends on the use of the memory regions. As a result, since this technique is based on a software implementation and depends on the application that results in the need, this technique is not 100% reliable.

There is thus a need to propose solutions to this problem that do not suffer from these drawbacks.

### SUMMARY

In accordance with an embodiment, a method for managing a memory within a system-on-a-chip including a processor, a memory and a firewall device, includes: generating, by the processor, a request to access the memory, where the request has a access permission level; controlling, by the firewall device, access to the at least one memory region of the memory as a function of the access permission level of the request and a respective access permission level associated with at least one memory region; and erasing, by the firewall device, the at least one memory regions when its respective access permission level is modified, where erasing comprises performing a hardware-implemented erasure.

In accordance with another embodiment, a system-on-a-chip includes: a memory; a processor coupled to the memory and configured to generate requests to access the memory, each of the requests having a respective access permission level; and a firewall device coupled to the memory and the processor. The memory includes a plurality of memory regions dedicated to respective access permission levels; at least one of the plurality of memory regions is dedicated to an access permission level that can be modified by the processor; the firewall device is configured to control access to at least one memory region as a function of the access permission level of the request and the respective access permission level associated with at least one memory region; and the firewall device is configured to erase the at least one memory region when the access permission level associated with the at least one memory region is modified, wherein the firewall device is configured to erase the at least one memory region by performing a hardware-implemented erasure.

In accordance with a further embodiment, a method includes: receiving a request from a first processor to access a memory region of a memory, the request comprising a first access permission level; comparing the first access permission level with a second access permission level associated with the memory region; granting or denying the request based on the comparing; receiving a command to modify the second access permission level of the memory region; and upon receiving the command, erasing the memory region by performing a hardware-implemented erasure, and changing the second access permission level of the memory region.

### BRIEF DESCRIPTION OF THE DRAWINGS

Other advantages and features of the invention will become apparent upon examining the detailed description of non-limiting embodiments and implementations, and from the accompanying drawings in which:

FIG. 1 illustrates a system-on-a-chip during a software initialization step according to an embodiment;

FIG. 2 illustrates the system-on-a-chip during a step of modifying the access permissions of a shared memory region according to an embodiment;

FIG. 3 illustrates the system-on-a-chip once an execution of a secure image display function is complete according to an embodiment;

FIG. 4 illustrates the system-on-a-chip during a tag identification step according to an embodiment;

FIG. 5 illustrates the system-on-a-chip after an erasure step according to an embodiment;

FIG. 6 illustrates the system-on-a-chip according to an alternative embodiment; and

FIG. 7 illustrates a block diagram of a system-on-a-chip according to an embodiment.

### DETAILED DESCRIPTION OF ILLUSTRATIVE EMBODIMENTS

Implementations and embodiments propose a technique for managing a memory within a system-on-a-chip allowing the security of the system to be enhanced in a simple and absolutely reliable manner, without complicating or slowing down the software system.

Embodiments and implementations relate to systems-on-chips integrating one or more processors communicating with a memory, in particular the management of the memory by a firewall device.

According to one aspect, the invention proposes a method for managing a memory within a system-on-a-chip including at least one processor, a memory and a firewall device.

Said at least one processor is configured to generate memory access requests, each having a respective access permission level.

The memory includes memory regions dedicated to respective access permission levels and at least one of the memory regions being dedicated to an access permission level that can be modified by the processor.

Moreover, the firewall device is configured to control access to the memory regions as a function of the access permission level of the requests and the permission level to which the respective memory region is dedicated.

The method comprises, in the event of a modification to the access permission level to which a memory region is dedicated, an erasure of the memory region hardware-implemented by the firewall device.

The memory regions correspond to a software organization of a memory into a plurality of data storage areas, the access permission level whereof being defined and managed by the firewall device.

The access permission level of the request can correspond, for example, to the access permission level of a software execution context of a software system or, for example, to an access permission level allocated to one of a plurality of processors that can use the memory.

For example, the memory can be an external or internal memory of the system-on-a-chip, of the random-access memory type (RAM) or of the non-volatile type (such as a “Flash” memory).

A modification to the access permission level means that the firewall device is reprogrammed to reconfigure the access conditions to one or more memory regions.

“Hardware-implemented erasure” is understood to mean that the firewall device is manufactured such that it always implements said erasure under conditions defined during the design of the circuit. This differs from a software implementation, which is for example controlled by a program executed by the software system.

In other words, the hardware implementation of the erasure according to this aspect completely eliminates the risk of data leakage caused by hacking or an error.

According to one implementation, the firewall device comprises, for each memory region, an attribute representative of the access permission level of the corresponding memory region, and is configured to control access to the memory regions by comparing the access permission level of the requests with the attribute of the respective memory region.

The method further comprises, in the event of a modification to the access permission level to which the memory region is dedicated by said at least one processor, modifying the attribute of the memory region after said erasure of the memory region hardware-implemented by the firewall device.

Modifying the attribute means that the firewall device redefines access to the memory region according to the access permission level to which this memory region is dedicated in the firewall device.

The memory region can thus be accessible to applications from a software execution context with the access level corresponding to the level redefined in the firewall once the attribute has been modified.

As a result, complete erasure of the memory region is ensured before the attribute of the memory region is modified, i.e. before it is made accessible to applications from other software execution contexts having the access level corresponding to the level redefined in the firewall.

As a result, this embodiment ensures that there is no possible security vulnerability that could cause data leakage during a “transitory” phase, for example during the erasure procedure.

According to one implementation, the firewall device further includes, for each possible access permission level modification, a tag communicating a condition for implementing said erasure and in the case of a modification to the access permission level to which the memory region is dedicated, said erasure of the memory region being hardware-implemented by the firewall device in a manner instructed by the condition communicated by the corresponding tag.

The tag can correspond to an indication concerning a change to the access permission level that may or may not undermine the security of the data contained in the memory region. For example, a modification from a first level of hierarchically lower access permissions to a second level of hierarchically higher access permissions can be acceptable without erasing the memory region. However, a modification from the second access permission level to the first access permission level can be qualified as capable of undermining data security, and an erasure of the memory region must be carried out.

As a result, checking the tag ensures that the memory region is erased during transitions between access permission levels that create security risks and that the process is not slowed down during transitions between access permission levels that do not create a security risk.

According to one implementation, the method further comprises the firewall device locking said memory region, blocking access to the memory region, during erasure.

The locking of the memory region corresponds to prohibiting access to this memory region, which prevents applications from all software execution contexts from reading or modifying the data stored in the memory region during erasure.

Again, this ensures that there are no security vulnerabilities that could cause data leakage in this way.

According to one implementation, the access permission levels comprise a secure level and a non-secure level, or a privileged level and a non-privileged level, or respective access permission levels of a plurality of processors that can access said memory.

The management of the secure and non-secure access permissions in particular allows access to a memory region for storing data for applications implementing critical security functions, such as the secure display of passwords, to be granted and denied. The management of the privileged and non-privileged access permissions allows access to a memory region for storing data for applications implementing sensitive functions, such as software system boot functions, to be granted and denied. More general management of processor access permissions also allows access to a memory region for storing specific data for one or more processors to be granted and denied.

The memory region can thus be accessed by applications from a software execution context according to the accesses configured in the firewall device. In systems comprising a plurality of processors, access to the memory region by each processor can also be configured in the firewall device.

For example, each processor within the same system-on-a-chip can provide for a plurality of software execution contexts with different access permission levels. According to these different permission levels, the software execution contexts within the same processor can access different memory regions provided that this processor has access to these memory regions.

According to one implementation, the memory further comprises a memory controller configured to erase at least one of the memory regions of the memory, and the erasure of said memory region comprises the firewall device transmitting an erase command to the memory controller.

A memory controller is a circuit that is typically integrated into the memory in particular allowing control signals to be received and processed in a given communication protocol, and the command actions to be implemented in the memory, such as reading, writing or erasing data.

According to one implementation, the erasure of said memory region comprises transmitting, from the firewall device, a burst of erase data in said memory region on a direct memory access bus.

In other words, when the memory is accessible via a direct memory access (DMA) bus, the firewall device can be advantageously configured to directly execute the erasure of the data in the memory.

According to another aspect, the invention further proposes a system-on-a-chip, including at least one processor, a memory and a firewall device, said at least one processor being configured to generate memory access requests, each having a respective access permission level, the memory including memory regions dedicated to respective access permission levels and at least one of the memory regions being dedicated to an access permission level that can be modified by the processor, the firewall device being configured to control access to the memory regions as a function of the access permission level of the requests and the permission level to which the respective memory region is dedicated.

The firewall device is hardware-configured, in the event of a modification to the access permission level to which a memory region is dedicated, to erase the memory region.

According to one embodiment, the firewall device comprises, for each memory region, an attribute representative of the access permission level of the corresponding memory region, and is configured to control access to the memory regions by comparing the access permission level of the requests with the attribute of the respective memory region, the firewall device being configured, in the event of a modification to the access permission level to which the memory region is dedicated, to modify the attribute of the memory region after the memory region has been erased by the firewall device.

According to one embodiment, the firewall device further includes, for each possible access permission level modification, a tag communicating a condition for implementing said erasure and, in the case of a modification to the access permission level to which the memory region is dedicated, the firewall device is configured to implement said erasure of the memory region in a manner controlled by the condition communicated by the corresponding tag.

According to one embodiment, the firewall device is further configured to lock the memory region, blocking access to the memory region, during erasure.

According to one embodiment, said access permission levels comprise a secure level and a non-secure level, or a privileged level and a non-privileged level, or respective access permission levels of a plurality of processors that can access said memory.

According to one embodiment, the memory further comprises a memory controller configured to erase at least one of the memory regions of the memory, and the firewall device is further configured to transmit an erase command to the memory controller to erase the memory region.

According to one embodiment, the firewall device is further configured to transmit a burst of erase data in the memory region on a direct memory access bus to erase the memory region.

FIG. 7 illustrates a block diagram of a system-on-a-chip SOC according to an embodiment of the present invention. As shown, system-on-a-chip SOC includes a processor PROC coupled to memory MEM via a firewall device FWL. In some embodiments, processor PROC may include multiple processors. In some embodiments, the components on the system-on-a-chip may be implemented on a single integrated circuit, such as single, monolithic integrated circuit. The integrated circuit may be implemented on a semiconductor substrate, such as a silicon substrate.

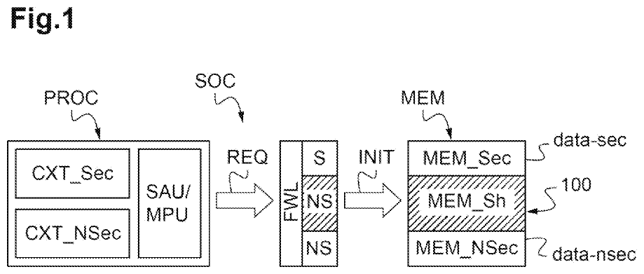

FIG. 1 shows a system-on-a-chip SOC, configured to operate with a software system, during a step 100 of initializing the software system according to an embodiment. The system-on-a-chip SOC includes a memory MEM wherein the program code of the software system is stored for example, a firewall device FWL and a processor PROC. The software system provides for software execution contexts with different access permission levels and, for each of these software execution contexts, applications. More particularly, the applications are derived from a software execution context and inherit the access permission level thereof.

The software system can provide, for example, an execution context with “secure” access permissions CXT_Sec (typically referred to as a “Secure OS”) and an application execution context with “non-secure” access permissions CXT_NSec (typically referred to as a “Rich OS”). Hereinafter and for simplification purposes, the terms “secure context” and “non-secure context” may be used to refer to a software execution context with secure access permissions Sec and to that with non-secure access permissions NSec respectively.

The processor PROC comprises an access permissions management unit SAU/MPU, and can execute the applications from the different software execution contexts, for example applications from the secure CXT_Sec and non-secure CXT_NSec contexts.

In particular, in a relatively simple system-on-a-chip SOC, the access permissions management unit SAU/MPU typically comprises a memory protection unit MPU adapted to manage the privileged Priv and non-privileged NPriv access permission levels.

Moreover, the access permissions management unit can comprise a secure attribution unit SAU adapted to manage the secure Sec and non-secure NSec access permission levels, in addition to the memory protection unit MPU. Alternatively, for a more complex system-on-a-chip, that is in particular capable of managing virtual addresses, the access permissions management unit (referred to as SAU/MPU in the figures) can comprise a memory management unit MMU adapted to manage privileged Priv, non-privileged NPriv, secure Sec and non-secure NSec access permission levels and to manage virtual addresses.

Secure Sec and non-secure NSec access permissions typically correspond to a physical separation of secure and non-secure hardware elements of the processor PROC.

The applications from the secure context CXT_Sec are generally provided to implement critical security functions via the secure hardware elements of the processor PROC. One example that can be cited is the function of securely displaying sensitive data on a screen.

The applications from the non-secure context CXT_NSec are typically provided to implement functions that do not impact the security of the system via the non-secure hardware elements of the processor PROC. These applications usually represent programs developed by third parties, which for example do not have the required permissions to handle the secure data of the software system.

The memory MEM includes memory regions dedicated to respective access permission levels, typically allocated during the initialization of the processor PROC and the software system.

The access permissions management unit SAU/MPU makes it possible, upon a command from the secure context of the processor PROC, to define an access permission level, in this case Sec and NSec, for the applications executed according to the contexts from which they originate, as well as for the memory regions of the memory MEM.

A secure memory region MEM_Sec is dedicated to a secure access permission level Sec and allows the secure data data-sec of the applications from the secure context CXT_Sec to be stored. A non-secure memory region MEM_NSec is dedicated to a non-secure access permission level NSec and allows the non-secure data data-nsec of the applications from the non-secure context CXT_NSec to be stored.

The MEM memory further includes a “shared” memory region MEM_Sh which is dedicated to an access permission level that can be modified by the processor PROC during the operation thereof. Thus, depending on the use made thereof, the memory region MEM_Sh can be dedicated to a secure access permission level Sec accessible to the applications from the secure context CXT_Sec, or can be dedicated to a non-secure access permission level NSec accessible to the applications from the non-secure context CXT_NSec.

Within the scope of the executions of applications by the processor PROC, memory access requests REQ can be generated. The memory access requests REQ each have a respective access permission level corresponding to the access permission level of the application executed by the processor PROC.

The firewall device FWL is configured to control access to the memory regions as a function of the access permission level of the requests REQ and the access permission level to which the respective memory region is dedicated. For example, the firewall device FWL can be an input/output peripheral acting as the interface between the processor PROC and the memory MEM. The processor PROC and the memory MEM can communicate via a data bus, in particular for the transmission of requests REQ and of data via the firewall device FWL.

In particular, the firewall device FWL comprises, for each memory region, an attribute representative of the access permission level of the corresponding memory region, for example attributes S and NS for memory regions with secure Sec and non-secure NSec access permissions respectively. The attribute of a memory region thus allows the firewall device FWL to compare the access permission level of the request REQ with the attribute of the corresponding memory region, and to grant or deny the request REQ as a function of the comparison.

The secure context CXT_Sec of the processor PROC, potentially via the access permissions management unit SAU/MPU, is furthermore capable of transmitting commands to modify the access permission level to which the memory region MEM_Sh is dedicated in the firewall device FWL, for example via the data bus.

As a result, a modification, for example, from the secure access permission level See to the non-secure access permission level NSec can be considered to be a transition that is capable of undermining the security of the system, in particular with regard to leakage of the data stored in the memory region MEM_Sh. More specifically, secure data data-sec can potentially remain in the shared memory region MEM_Sh after the transition, and thus become accessible by a non-secure third-party application.

In this respect, an erasure of the memory region MEM_Sh is hardware-implemented by the firewall device FWL in the event of a modification to the access permission level to which the memory region MEM_Sh is dedicated. Thus, the erasure of the memory region MEM_Sh during the transition is hardware-implemented, in an unavoidable manner, by the firewall device FWL, and leakage of the secure data data-sec stored in the shared memory region MEM_Sh is impossible in this way.

Advantageously, the firewall device FWL includes a bank of tags labelling, for each possible transition from one access permission level to another, if the transition is capable of undermining the security of the software system. The tag bank can, for example, be provided during the manufacture of the system-on-a-chip SOC as a function of the types of access permission levels that can be used by the system-on-a-chip SOC, or can be configured by the secure execution context CXT_Sec of the processor PROC for example during the initialization of the software system.

The respective tags at each access permission level transition, allow for the communication of the erase command, hardware-implemented by the firewall device FWL, of the memory region MEM_Sh whose access permission level has been modified.

In other words, the erasure of the memory region MEM_Sh is hardware-implemented by the firewall device FWL in a manner controlled by the condition communicated by the respective tag TAG(S->NS) or TAG(NS->S).

In particular, in the example of the “secure” and “non-secure” access permission levels, two transitions are possible: a first transition from the non-secure access permission level NSec to the secure access permission level Sec, or a second transition from the secure access permission level Sec to the non-secure access permission level NSec. Either or both of said transitions can be considered to be capable of undermining the security of the software system.

Thus, a first tag TAG(S->NS) is associated with the first transition, and a second tag TAG(NS->S) is associated with the second transition. The first tag TAG(S->NS) and the second tag TAG(NS->S) communicate an erase implementation condition in the event of a command to modify the access permission levels of the memory region corresponding to the respective transition.

The initialization step 100 represents the step wherein access to the memory regions are configured in the firewall device FWL. During this step, the secure context CXT_Sec of the processor PROC transmits a command to the firewall device FWL to define the access permission level of the memory region MEM_Sh.

The choice of which access permission level is to be defined for the “shared” memory region MEM_Sh can take into account several factors, such as the memory resource requirements of the applications from the secure context CXT_Sec and non-secure context CXT_NSec, and the fact that some of these resources can only be accessed by one software execution context at a time. It is also important to consider this resource requirement after the initialisation step, in particular when applications from each context generate a request REQ for the first time, in order to determine a storage space adapted to each software execution context.

Preferably, it is thus provided that the access permission level to which the memory region MEM_Sh is dedicated is defined as non-secure NSec. The memory region MEM_Sh thus increases the storage space allocated to the applications from the non-secure context CXT_NSec which typically require more memory resources, in particular when executing certain functions such as image displays.

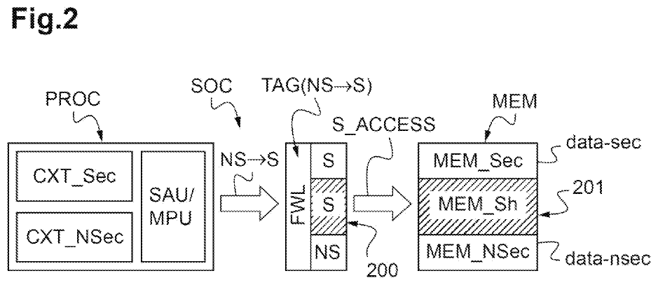

Reference is now made to FIG. 2, which shows the system-on-a-chip SOC described hereinabove with reference to FIG. 1, during a step 200 of modifying the access permissions of the shared memory region MEM_Sh, and, during a step 201 of identifying a tag TAG(NS->S) and of storing secure data data-sec.

An application from the secure context CXT_Sec wishes to run a secure display function with rotation of a secure image. In practice, this type of function consumes a first secure memory region for displaying the secure image and a second secure memory region for rotating this image. In the case of a high-resolution image, each memory region is large in size, for example 8 MB for a 1080p resolution. In this example, the secure memory region MEM_Sec alone is not considered to have sufficient space to store the data for this function.

In step 200, the system-on-a-chip SOC will allocate the shared memory region MEM_Sh to the secure context CXT_Sec of the processor PROC, “NS->S”. The non-secure context CXT_NSec frees up the use of the shared memory region MEM_Sh, and the secure context CXT_Sec reconfigures the firewall device FWL so that the shared memory region MEM_Sh is dedicated to the secure access permission level Sec.

In the optional step 201, the firewall device FWL identifies a tag TAG(NS->S) associated with the transition of the access permission level of the memory region MEM_Sh. The tag TAG(NS->S) indicates, for example, that no erasure is required for this transition, allowing the firewall device FWL to immediately reconfigure access to the memory region MEM_Sh by allocating the attribute S thereto.

The secure context CXT_Sec of the processor PROC can access S_ACCESS the memory MEM via the firewall device FWL. Thus, the applications from the secure context CXT_Sec can store secure data data-sec in the memory region MEM_Sh such as display data of the secure frames resulting from the rotation of the image.

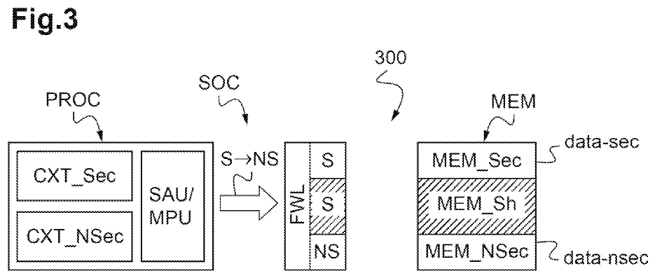

FIG. 3 shows the system-on-a-chip SOC described hereinabove with reference to FIG. 2, during a step 300, once the execution of the secure image display function is complete. The memory region MEM_Sh can be freed up by the secure context CXT_Sec and made available to the non-secure context CXT_NSec again.

The secure context CXT_Sec of the processor PROC generates a command “S->NS” in this respect to define a non-secure access permission level NSec for the memory region MEM_Sh in the firewall device FWL.

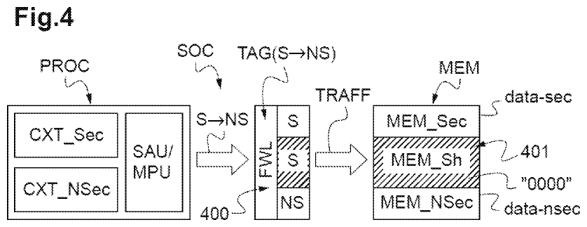

FIG. 4 shows the system-on-a-chip SOC described hereinabove with reference to FIG. 3, during a tag TAG(S->NS) identification step 400, and during a step 401 of erasing the memory region MEM_Sh.

In step 400, the firewall device FWL identifies a tag TAG(S->NS) associated with the transition of the access permission level of the memory region MEM_Sh. The tag TAG(S->NS) indicates, for example, to the firewall device FWL that this transition is capable of undermining the security of the system and thus communicates a command to erase the memory region MEM_Sh.

In step 401, the erasure of the memory region MEM_Sh is hardware-implemented by the firewall device FWL and allows the secure data data-sec stored in the memory region MEM_Sh to be replaced with other erase data TRAFF according to a defined model. These erase data TRAFF can be data encoded on a number n of bits corresponding to the size of the memory region, of value 0 or of an arbitrary value.

Furthermore, the firewall device FWL can advantageously lock the memory region MEM_Sh during erasure. The firewall device FWL thus blocks, for example, all access to the memory region MEM_Sh, regardless of the access permission level of the requests REQ to access the memory MEM.

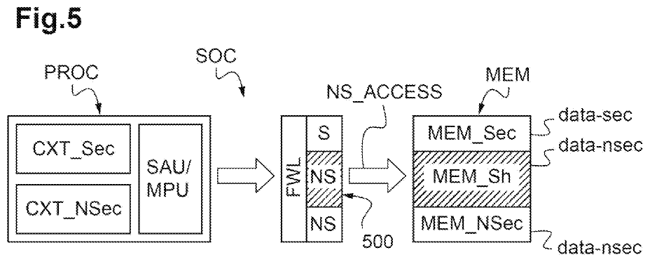

FIG. 5 shows the system-on-a-chip SOC described hereinabove with reference to FIG. 4, during a step 500, after the end of the erasure of the shared memory region MEM_Sh, wherein the attribute S, NS is effectively modified in the firewall device FWL. Step 500 finalizes the process of modifying the access permissions of the shared memory region MEM_Sh, in response to the command to allocate said region to the secure context CXT_Sec. The state of the system-on-a-chip SOC in step 500 corresponds to the state of the system-on-a-chip SOC in the initialization step 100.

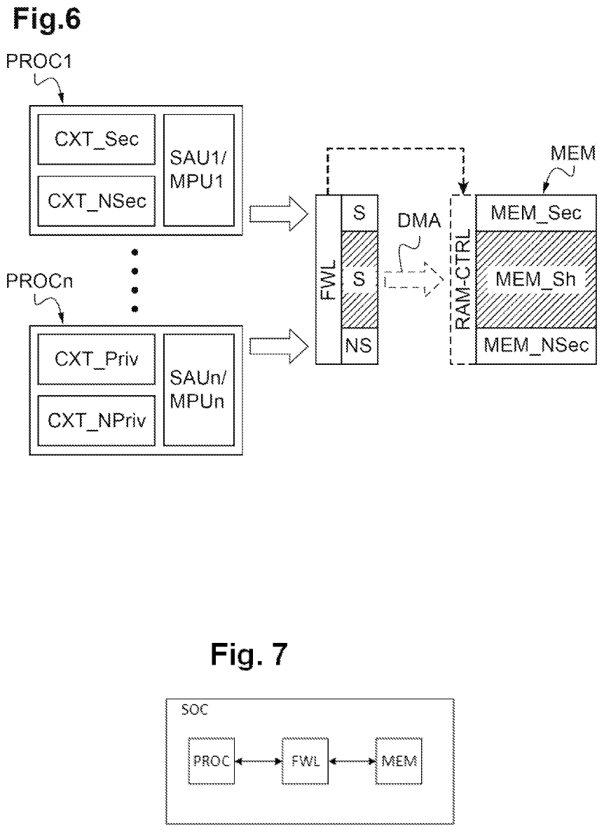

FIG. 6 shows examples of alternatives to the system-on-a-chip SOC described hereinabove with reference to FIGS. 1 to 4. On the one hand, a plurality of processors PROC1 to PROCn can communicate with the memory MEM via the firewall FWL.

The system-on-a-chip SOC can provide both secure See and non-secure NSec access permissions and, for each secure and non-secure hardware domain, privileged Priv and non-privileged NPriv access permissions. However, processors PROCn can provide for only privileged Priv or non-privileged NPriv access permission levels. Thus, the firewall device FWL can further comprise attributes P and NP representative of the privileged Priv and non-privileged NPriv access permission levels respectively.

Furthermore, the different processors PROC1-PROCn can “own” respective memory regions, i.e., memory regions are respectively dedicated to the different processors, and, the firewall device FWL can further comprise attributes (not shown) representative of the processors PROC1-PROCn owning the respective memory regions. The ownership of a memory region by a processor PROC-PROCn is also considered to be an access permission level.

For example, the aforementioned attributes P-NP (resp. S-NS) can be provided so as to communicate both information representative of the privileged Priv and non-privileged NPriv (resp. secure See and non-secure NSec) access permission levels and information representative of the respective owner processor PROC1-PROCn.

Access permissions management is also provided such that a non-privileged NPriv level task cannot access privileged Priv level data or functions. These privileged Priv and non-privileged NPriv access permission levels allow in particular the access to a memory region to be granted or respectively denied for the storage of data of applications implementing sensitive functions, such as functions handling the boot data of the software system.

In this alternative embodiment, an access permission level per processor can also be considered, for which the firewall device FWL is capable of granting or denying access to the memory region MEM_Sh. In such a case, attributes corresponding to the access permission levels per processor can be provided in the firewall device FWL.

Whatever the types of access permissions used (secure/non-secure and/or privileged/non-privileged and/or associated with respective processors), the firewall device FWL is hardware-configured, in the case of a modification to the access permission level to which a memory region MEM_Sh is dedicated, to erase the memory region MEM_Sh, potentially via the optional and advantageous mechanism of the tags, for each possible access permission level modification, communicating an implementation condition for said erasure.

The erasure can, for example, be a transmission by the firewall device FWL of a burst of erase data TRAFF in the memory region MEM_S by a direct memory access mechanism DMA. Thus, the secure data data-sec stored in the memory region MEM_Sh are overwritten and erased.

In another example of implementing the erasure, the memory MEM comprises a memory controller MEM_CTRL. The memory controller MEM_CTRL can be provided in most random-access memories “RAMs” and allow control signals to be received and processed in a given communication protocol, and the command actions to be implemented in the memory MEM, such as reading, writing or erasing data. In such a case, the firewall device FWL can thus transmit a command to the memory controller MEM_CTRL to erase the memory region MEM_SH.

Furthermore, the invention is not limited to these embodiments and implementations, but encompasses all alternative embodiments, for example the specific “secure” and “non-secure” access permission levels described with reference to FIGS. 1 to 5 have been given by way of example, and could be replaced by any other type of access permission level, such as, for example, the access permission levels mentioned with reference to FIG. 6.

Moreover, although an advantageous mechanism using access permission level transition tags has been described, the invention can provide, for example, for hardware-implemented erasure by the firewall device FWL whenever the access permissions of a memory region are modified.

What is claimed is:

1. A method for managing a memory within a system-on-a-chip including a processor, a memory and a firewall device, wherein the memory includes a plurality of memory regions dedicated to respective access permission levels and at least one memory region of the plurality of memory regions is dedicated to an access permission level that can be modified by the processor, the method comprising:
generating, by the processor, a request to access the memory, wherein the request has a access permission level;
controlling, by the firewall device, access to the at least one memory region as a function of the access permission level of the request and the respective access permission level associated with at least one memory region; and
erasing, by the firewall device, the at least one memory regions when its respective access permission level is modified, wherein erasing comprises performing a hardware-implemented erasure.

2. The method according to claim 1, wherein:
the firewall device comprises attributes representative of access permission levels corresponding to each memory region of the plurality of memory regions;
controlling, by the firewall device, access to the at least one memory region comprises comparing the access permission level of the request with the attribute associated with the at least one memory region; and
the method further comprises, when the access permission level to the at least one memory region is modified, modifying the attribute corresponding to the at least one memory region after the erasing of the at least one of the memory regions.

3. The method according to claim 1, wherein:
the firewall device further includes, for each possible access permission level modification, a tag communicating a condition for implementing the erasing; and
when the access permission level to the at least one memory region is modified, performing the erasing of the at least one memory region in a manner instructed by the condition communicated by the tag.

4. The method according to claim 1, further comprising, during the erasing, locking, by the firewall, the at least one memory region to block access to the at least one memory region.

5. The method according to claim 1, wherein the access permission levels comprise:
a secure level and a non-secure level; or
a privileged level and a non-privileged level; or
respective access permission levels of a plurality of processors that can access the memory.

6. The method according to claim 1, wherein the erasing of the at least one memory region comprises the firewall device transmitting an erase command to a memory controller configured to erase the at least one memory region.

7. The method according to claim 1, wherein the erasing comprises the firewall device transmitting a burst of erase data to the at least one memory region via a direct memory access bus.

8. A system-on-a-chip comprising:
a memory;
a processor coupled to the memory and configured to generate requests to access the memory, each of the requests having a respective access permission level; and
a firewall device coupled to the memory and the processor, wherein
the memory comprises a plurality of memory regions dedicated to respective access permission levels,
at least one of the plurality of memory regions is dedicated to an access permission level that can be modified by the processor,
the firewall device is configured to control access to at least one memory region as a function of the access permission level of the request and the respective access permission level associated with at least one memory region, and
the firewall device is configured to erase the at least one memory region when the access permission level associated with the at least one memory region is modified, wherein the firewall device is configured to erase the at least one memory region by performing a hardware-implemented erasure.

9. The system-on-a-chip according to claim 8, wherein:
the firewall device comprises attributes representative of access permission levels corresponding to each memory region of the plurality of memory regions,
the firewall device is configured to control access to the at least one memory region by comparing the access permission level of the request with the attribute associated with the at least one memory region,
the firewall device is configured to, when the access permission level to the at least one memory region is modified, modify the attribute corresponding to the at least one memory region after erasing of the at least one memory region.

10. The system-on-a-chip according to claim 8, wherein:
the firewall device further includes, for each possible access permission level modification, a tag communicating a condition for implementing the erasure, and
the firewall device is configured to, when the access permission level to the at least one memory region, erase the at least one memory region a manner instructed by the condition communicated by the tag.

11. The system-on-a-chip according to claim 8, wherein the firewall device is further configured to lock the memory region to block access to the memory region, during the erasure.

12. The system-on-a-chip according to claim 8, wherein the access permission levels comprise:
a secure level and a non-secure level; or
a privileged level and a non-privileged level; or
respective access permission levels of a plurality of processors that can access said memory.

13. The system-on-a-chip according to claim 8, wherein:
the memory further comprises a memory controller configured to erase the at least one memory region; and
the firewall device being further configured to transmit an erase command to the memory controller to erase the at least one memory region.

14. The system-on-a-chip according to claim 8, wherein the firewall device is further configured to transmit a burst of erase data in the memory region on a direct memory access bus to erase the at least one memory region.

15. The system-on-a-chip according to claim 8, wherein the processor comprises a plurality of processors.

16. The system-on-a-chip according to claim 8, wherein:
the processor is configured to execute applications from different software execution contexts, wherein the different software execution contexts comprise secure contexts and non-secure contexts; and
the processor comprises a permissions management unit configured to manage the respective access permission levels of the requests based on the different software execution contexts.

17. A method, comprising:
receiving a request from a first processor to access a memory region of a memory, the request comprising a first access permission level;
comparing the first access permission level with a second access permission level associated with the memory region;
granting or denying the request based on the comparing;
receiving a command to modify the second access permission level of the memory region; and
upon receiving the command, erasing the memory region by performing a hardware-implemented erasure, and changing the second access permission level of the memory region.

18. The method of claim 17, further comprising blocking access to the memory region while erasing the memory region.

19. The method of claim 17, further comprising receiving a request from a second processor to access the memory region.

20. The method of claim 17, further comprising:
providing access to the memory region to the first processor to perform a secure function before receiving the command to modify the second access permission level; and
providing access to the memory region to the first processor or a second processor to perform a non-secure function after erasing the memory and changing the second access permission level of the memory region.
